(19) United States
(12) Patent Application Publication
(10) Pub. No.: US 2010/0029809 A1
(43) Pub. Date: Feb. 4, 2010

(54) COMPOSITE MATERIAL COMPOSED OF NATURAL VEGETABLE FIBER AND SYNTHETIC POLYMER, AND METHOD FOR PRODUCING THE SAME

(75) Inventor: Shin-ichi Kuroda, Gunma (JP)

Correspondence Address: GREENBLUM & BERNSTEIN, P.L.C., 1950 ROLAND CLARKE PLACE, RESTON, VA, 20191, US

(73) Assignee: NATIONAL UNIVERSITY CORPORATION GUNMA UNIVERSITY, Gunma (JP)

(21) Appl. No.: 12/447,929

(22) PCT Filed: Oct. 29, 2007
(86) PCT No.: PCT/JP2007/070986

§ 371 Date: May 21, 2009

(30) Foreign Application Priority Data
Oct. 30, 2006 (JP) 2006-293832

(51) Int. Cl. C08L 97/02

(52) U.S. Cl. 524/9

(57) ABSTRACT

A composite material is provided which is lightweight, mechanically strong, and excellent in formability and water resistance, and is capable of reducing an environmental burden. A production method of the composite material composed of a natural vegetable fiber and a synthetic polymer includes chemically bonding a molecular chain of the synthetic polymer to a surface of the natural vegetable fiber; kneading the chemically bonded fiber and a synthetic polymer of a type one of identical to and different from the synthetic polymer used in the chemical bonding; and forming the obtained kneaded material into a predetermined shape.

### BACKGROUND OF THE INVENTION

1. Field of the Invention

The present invention relates to a composite material composed of a natural vegetable fiber and a synthetic polymer, the composite material having excellent formability, water resistance, and thermal stability; and a production method of the composite material.

2. Description of Related Art

Glass fiber reinforced plastic (hereinafter referred to as “GFRP”) is the most mass produced and widely used fiber reinforced plastic among fiber reinforced composite materials. In view of compatibility with environment, however, use of GFRP has recently been curbed. Specifically, burning GFRP generates residue containing many glass filaments, which cannot be decomposed in a disposal method compatible with environment. In addition, glass dust generated during processing of GFRP may cause allergic symptoms or skin inflammations in process workers.

Plastic reinforced by natural fibers has been drawing attention instead of GFRP. Natural fiber reinforced plastic (hereinafter referred to as “NFRP”) can be burned without generation of glass residue. Particularly, as far as natural fibers composing NFRP are concerned, an amount of carbon dioxide generated along with burning of natural fibers is no more than an amount of carbon dioxide that plants have taken in when they grew. It is thus expected to balance out production and consumption of carbon dioxide, which has been strictly regulated in light of recent global warming. In addition to the environmental aspect, NFRP, which has a low fiber density and low brittleness, is expected as a lightweight composite material having high toughness in terms of mechanical property.

Research of NFRP has extensively been conducted since the 1980s, with respect to composite materials using wood fibers. A prominent trend since the 1990s, however, is use of annual plants represented by kenaf fibers. For instance, a composite material is presented having 50 weight % (39 volume %) of a kenaf fiber and a polypropylene (refer to Non-patent Literature 1, for example). The composite material exhibits performance equivalent to a composite material having 40 weight % (19 volume %) of a glass fiber added to a polypropylene. Against the backdrop of the research results, NFRP has been employed for vehicle underbody panels since the beginning of 2000.

Further, a fiber reinforced plastic composition is disclosed (refer to Patent Literature 1, for example), the fiber reinforced plastic composition being produced by mixing at a predetermined ratio a natural fiber, such as a kenaf fiber and the like, which has undergone surface treatment with a compatibilizer, and a thermoplastic resin material, such as olefinic material and the like; and by heating and kneading the mixture under a predetermined condition.

The inventors of the present invention has discovered that when a vegetable fiber was treated with a nitric acid solution of a cerium salt, which was a strong oxidant, and then acted on by methyl methacrylate, a polymer chain of polymethylmethacrylate was grafted on a surface of the vegetable fiber. The inventors has then pointed out a possibility of a new vegetable fiber and polymer composite material (refer to Non-patent Literature 2).

[Non-patent Literature 1] Sanadi, A. R., et al., 7th Annual Conference of the International Kenaf Association (1995)

[Non-patent Literature 2] Kuroda, S., et al., “Advance on Chemical Engineering and New Material Science,” Liaoning Science and Technology Publishing House (2002), pp. 94-98

[Patent Literature 1] Japanese Patent Laid-open Publication No. 2004-114436 (claims 1 and 7)

Conventional NFRP described in Non-patent Literature 1 and Patent Literature 1, however, has a limitation on types of matrix polymers used in order to reinforce bonding strength at an interface between a natural vegetable fiber and a matrix polymer. More specifically, the conventional NFRP requires that a polymer having a polar character be used as a matrix. Alternatively, the conventional NFRP requires that a natural vegetable fiber surface be treated with a silane coupling agent; or that a maleic acid-denatured polyolefin be added. However, the silane coupling agent is a low-molecular-weight compound, and the maleic acid-denatured polyolefin has a molecular weight of less than about 10,000. Thus, the conventional NFRP does not have sufficient strength at the interface of the disperse phase and matrix. The obtained composite material also falls short of sufficient water resistance and thermal resistance.

The vegetable fiber and polymer composite material described in Non-patent Literature 2 is disadvantageous in that a cerium salt and a nitric acid, which pose a high environmental burden, have to be used in a production process.

### SUMMARY OF THE INVENTION

A purpose of the present invention is to provide a composite material composed of a natural vegetable fiber and a synthetic polymer, the composite material being lightweight, mechanically strong, and excellent in formability and water resistance, and being capable of reducing an environmental burden. The present invention also provides a production method of the composite material.

A second aspect of the present invention provides a production method of a composite material composed of a natural vegetable fiber and a synthetic polymer. The production method includes chemically bonding a molecular chain of a polystyrene, which is the synthetic polymer, to a surface of the natural vegetable fiber by treating the natural vegetable fiber with hydrogen peroxide solution, and thus introducing a peroxide group in the fiber surface; and then by contacting a styrene, which is a vinyl monomer, to the fiber in which the peroxide group is introduced in the surface, and thus graft-polymerizing the polystyrene on the fiber surface using the peroxide group as a polymerization initiator; kneading the fiber to which the molecular chain of the polystyrene is chemically bonded, and a synthetic polymer of a type one of identical to and different from the synthetic polymer used in the chemical bonding; and forming the obtained kneaded material into a predetermined shape.

A third aspect of the present invention provides a production method of a composite material composed of a natural vegetable fiber and a synthetic polymer. The production method includes chemically bonding a molecular chain of a polystyrene, which is the synthetic polymer, to a surface of the natural vegetable fiber by irradiating the natural vegetable fiber with plasma, and thus introducing a peroxide group in the fiber surface; and then by contacting a styrene, which is a vinyl monomer, to the fiber in which the peroxide group is introduced in the surface, and thus graft-polymerizing the polystyrene on the fiber surface using the peroxide group as a polymerization initiator; kneading the fiber to which the molecular chain of the polystyrene is chemically bonded, and a synthetic polymer of a type one of identical to and different from the synthetic polymer used in the chemical bonding; and forming the obtained kneaded material into a predetermined shape.

A fourth aspect of the present invention provides a production method of a composite material composed of a natural vegetable fiber and a synthetic polymer. The production method includes causing a radial generator to act on the synthetic polymer having one of a polypropylene, a polyethylene, and a polystyrene, in the presence of a methacryloxypropyltrimethoxysilane, which is a vinyl group-containing alkoxysilane monomer, and thus graft-polymerizing the alkoxysilane monomer on the synthetic polymer; chemically bonding a molecular chain of the synthetic polymer to a surface of the natural vegetable fiber by dehydrating and condensing an alkoxysilane group and a hydroxyl group, the alkoxysilane group being graft-polymerized on the synthetic polymer, the hydroxyl group being present in the surface of the natural vegetable fiber; kneading the chemically bonded fiber and a synthetic polymer of a type one of identical to and different from the synthetic polymer used in the chemical bonding; and forming the obtained kneaded material into a predetermined shape.

A fifth aspect of the present invention provides the production method according to the second or third aspect, wherein the natural vegetable fiber is a kenaf fiber, the monomer is a styrene, and the synthetic polymer is a polystyrene (hereinafter referred to as PS).

A sixth aspect of the present invention provides the production method according to the fourth aspect, wherein the natural vegetable fiber is a kenaf fiber, the monomer is a methacryloxypropyltrimethoxysilane, and the synthetic polymer is a polypropylene (hereinafter referred to as PP).

A seventh aspect of the present invention provides the production method according to the fourth aspect, wherein the natural vegetable fiber is a kenaf fiber, the monomer is a methacryloxypropyltrimethoxysilane, and the synthetic polymer is a polyethylene (hereinafter referred to as PE).

An eighth aspect of the present invention provides the production method according to the fourth aspect, wherein the natural vegetable fiber is a kenaf fiber, the monomer is a methacryloxypropyltrimethoxysilane, and the synthetic polymer is PS.

A ninth aspect of the present invention provides a composite material composed of a natural vegetable fiber and a synthetic polymer, the composite material being produced in the method according to one of the second through eighth aspects.

In the present production method of the composite material composed of the natural vegetable fiber and the synthetic polymer, the molecular chain of the synthetic polymer, which is chemically bonded to the natural vegetable fiber surface, increases adhesion to the matrix. Further, the composite material obtained in the present production method is lightweight, mechanically strong, and excellent in formability and water resistance. The composite material also features no generation of residue that burdens the environment when being burned.

### BRIEF DESCRIPTION OF THE DRAWINGS

FIG. 1 is a photograph of a composite material obtained in Embodiment 5.

### DETAILED DESCRIPTION OF PREFERRED EMBODIMENTS

Preferred embodiments of the present invention are explained below.

Examples of a natural vegetable fiber according to the present invention include kenaf, cotton, jute, Manila hemp, saisal hemp, bamboo, fiber pulp, used paper, and the like. Among the above listed examples, kenaf is preferable because the fiber grows very fast and provides a high fiber yield per unit area, and thus absorbs a large amount of carbon dioxide from the air. Thereby, kenaf reduces greenhouse effects from carbon dioxide, and exhibits effects in prevention of global warming. Further, it is preferable in view of easy handling and processing that a natural vegetable fiber is cut into a desired length of about 2 mm to 5 mm when the fiber is provided for the production method of the present invention.

A production method of a composite material composed of a natural vegetable fiber and a synthetic polymer according to the present invention includes chemically bonding a molecular chain of the synthetic polymer to a surface of the natural vegetable fiber; kneading the chemically bonded fiber and a synthetic polymer of a type identical to or different from the synthetic polymer used in the chemical bonding; and forming the obtained kneaded material into a predetermined shape.

There are two methods for chemically bonding the molecular chain of the synthetic polymer to the surface of the natural vegetable fiber according to the production method of the present invention. In a first method, a peroxide group is introduced in the fiber surface, and then the synthetic polymer is graft-polymerized using the peroxide group as a polymerization initiator. In a second method, a radical is generated in the synthetic polymer; subsequently, a vinyl group-containing alkoxysilane monomer is graft-polymerized; and then an alkoxysilane group and a hydroxyl group are dehydrated and condensed, the alkoxysilane group being graft-polymerized on the synthetic polymer, the hydroxyl group being present in the surface of the natural vegetable fiber.

The first method is discovered based on detailed analysis of the results of Non-patent Literature 2 and findings of the chemical reaction mechanism. In the method, pretreatment is performed to generate a peroxide group in the fiber surface, before the natural vegetable fiber and the synthetic polymer are combined. Performing the pretreatment allows graft polymerization even on a natural vegetable fiber having a high lignin content. Specifically, the pretreatment increases a graft rate when the synthetic polymer is graft-polymerized since the peroxide group acts as a polymerization initiator, and thereby increases adhesion of the synthetic polymer to the fiber surface. In addition, the structure based on a high lignin content and graft polymerization treatment increases thermal stability of the composite material, and thus reduces its water absorption rate. Further, increasing the graft rate facilitates forming and processing of fibers having undergone graft polymerization. The pretreatment is performed in a wet method or a dry method. The wet method treats a natural vegetable fiber by immersing the fiber in hydrogen peroxide solution having an oxidizing power. In the wet method, the natural vegetable fiber may be treated with a hydrogen peroxide as it is, so as to introduce a peroxide group in the fiber surface. Further, when the natural vegetable fiber is oxidized with an orthoperiodic acid, an aldehyde group is introduced in the surface. Thus, when the oxidized fiber is treated with a hydrogen peroxide, more peroxide groups can be introduced in the fiber surface. In the dry method, a natural vegetable fiber is irradiated with plasma.

For instance, a bell-jar type plasma reactor is prepared, in which a natural vegetable fiber is placed between two electrodes provided therein. In an oxygen-containing atmosphere inside the reactor, plasma is generated by supplying a predetermined voltage between the electrodes from a high frequency power source connected to one of the electrodes. Thereby, plasma is irradiated on the natural vegetable fiber provided between the electrodes. Conditions for plasma irradiation when the bell-jar type plasma reactor is used include, for example, that a high frequency power source (13.56 MHz) is used; that a pressure inside the reactor is reduced to 5 Pa; that an oxygen gas is supplied until the pressure inside the reactor is stabilized around 20 Pa, and thus an oxygen gas atmosphere is provided thereinside; and that plasma is irradiated at an output power of 10 W to 50 W for a duration of 5 to 15 minutes. Irradiating the natural vegetable fiber with plasma under the conditions above introduces a peroxide group in the surface of the natural vegetable fiber.

Thereafter, the fiber, in which the peroxide group is introduced in the surface in the wet or dry method, is contacted with a vinyl monomer. When the fiber and monomer are contacted, the peroxide group acts as a polymerization initiator, and thus the synthetic polymer is graft-polymerized on the fiber surface. In the first method, it is preferable to use a styrene as the vinyl monomer contacted to the fiber. When a styrene is used as the monomer, the synthetic polymer graft-polymerized on the fiber surface is PS.

In the second method, the synthetic polymer is first acted on by a radical generator in the presence of a vinyl group-containing alkoxysilane monomer, and thereby the synthetic polymer is graft-polymerized with the alkoxysilane monomer. As shown in chemical formula 1, for example, a PE film is used as the synthetic polymer; a vinyl monomer is used as the vinyl group-containing alkoxysilane monomer; and a xanthone is used as the radical generator. The PE film and the vinyl monomer are immersed in a solution in which the xanthone is dissolved, and are then irradiated with ultraviolet having a wavelength of 300 nm or greater while being stirred, whereby a film is obtained in which PE is graft-polymerized with the vinyl monomer. The vinyl monomer in chemical formula 1 is expressed as CH₂═CH—F, which is a simplified expression. In the graft polymerization reaction of chemical formula 1, a methacryloxypropyltrimethoxysilane expressed in subsequent chemical formula 2 is used as the vinyl monomer. The radical generator used herein may be selected from any chemical compound as long as the compound generates a radical in the synthetic polymer by heating or light irradiation. Examples of the radical generator other than a xanthone include organic peroxides, such as a benzoyl peroxide (BPO) and the like, and azo compounds, such as an azobisisobutyronitrile (AIBN).

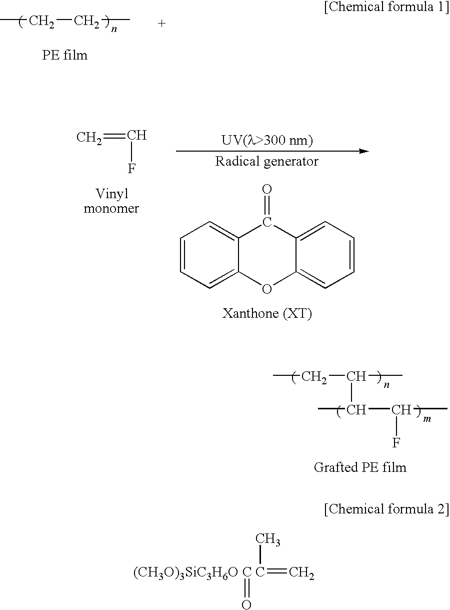

In the second method, it is preferable to use a methacryloxypropyltrimethoxysilane as the monomer, and PP, PE, or PS as the synthetic polymer. Further, an amount of the monomer graft-polymerized with the synthetic polymer is preferably 25 weight % or less of the synthetic polymer, more preferably 2 weight % to 15 weight % thereof. The synthetic polymer graft-polymerized with the alkoxysilane monomer in the method above is very active. In addition, since the active synthetic polymer can be synthesized before being chemically bonded to the fiber, the second method is more practical than the first method. A PE film is used on chemical formula 1 as the synthetic monomer. A shape of PE is not limited to a film, but may be powder, pellets, or a solution.

Subsequently, the alkoxysilane group and the hydroxyl group are dehydrated and condensed, the alkoxysilane group being graft-polymerized on the synthetic polymer, the hydroxyl group being present in the surface of the natural vegetable fiber. The hydroxyl group, which is present in the surface of the natural vegetable fiber, can easily be dehydrated and condensed with the active synthetic polymer. In the second method, the synthetic polymer is dehydrated and condensed with the hydroxyl group present in the fiber surface, on a position where the synthetic polymer is graft-polymerized with the alkoxysilane monomer. Thus, bonding is not limited to a pattern of the first method, in which only an end of the synthetic polymer is bonded to the fiber surface. Bonding patterns of the second method include bonding along a molecular chain of the synthetic polymer, and bonding at a plurality of positions in one molecule of the synthetic polymer. The process for dehydrating and condensing the alkoxysilane group graft-polymerized with the synthetic polymer and the hydroxyl group present in the surface of the natural vegetable fiber, can be performed concurrently with kneading in a kneading process described hereinafter.

Performing the first or second method as described above chemically bonds the molecular chain of the synthetic polymer having a high-molecular weight to the surface of the natural vegetable fiber.

Thereafter, the fiber having the molecule chain of the synthetic polymer chemically bonded to the surface thereof in the above-described first or second method, is kneaded with a synthetic polymer. As described above, when the synthetic polymer obtained in the second method in which the alkoxysilane group is graft-polymerized, is kneaded with the synthetic polymer even as it is along with the vegetable fiber, dehydration and condensation progress during the kneading between the alkoxysilane group and the hydroxide group present in the natural vegetable fiber surface, and thus the process can be simplified. The synthetic polymer used herein may be a synthetic polymer of a type identical to the synthetic polymer used for the chemical bonding or a synthetic polymer of a different type, in accordance with a purpose of use of the composite material. A high content rate of the natural vegetable fiber in the kneaded material can reduce an environmental burden. There is a tendency, however, to adversely affect formability. A low content rate has a limited impact on reduction in environmental burden, but tends to increase formability.

Then, the obtained kneaded material is formed into a predetermined shape. Conventional forming methods may be used, including hot press, extrusion molding, injection molding, and the like. For instance, the kneaded material is extrusion-molded from a mold using an extrusion molder, and thus formed into a strand shape. The obtained material is then cut into pellets, which are formed into a desired shape in injection molding.

In the processes above, the composite material, which is a natural fiber reinforced plastic, is obtained composed of the natural vegetable fiber and the synthetic polymer. The composite material according to the present invention features no generation of residue that burdens the environment when being burned, and thus reduces the environmental burden. Since the composite material includes the fiber to which the molecular chain of the synthetic polymer is chemically bonded, the material is lightweight, mechanically strong, and excellent in formability and water resistance.

The embodiments of the present invention are explained below along with comparative examples.

### Embodiment 1

A kenaf bast fiber washed with water was placed in a polymerization tube, along with hydrogen peroxide solution having a predetermined concentration, and a methansulfonic acid or a hydrochloric acid. The kenaf bast fiber was held therein for three hours at a temperature of 30° C. Thereby, a peroxide group was introduced in a fiber surface. An amount of the introduced peroxide group was then measured.

Meanwhile, the fiber in which the peroxide group was introduced in the surface was placed in a polymerization tube, along with a predetermined amount of styrene and the same mount of water. The styrene was then graft-polymerized on the fiber surface for 12 hours at a temperature of 60° C. in a nitrogen atmosphere. Thereafter, a soxhlet extraction was performed so as to remove impurities not grafted on the fiber surface. A graft rate was then obtained as follows: [(Post-graft weight−Pre-graft weight)/Pre-graft weight]×100%. The results are shown in Table 1 below.

TABLE 1

| | | | Peroxide | |
|---|---|---|---|---|
| Hydrogen | | | group amount | |
| peroxide | Methansulfonic | Hydrochloric | (meq/100 g | Graft rate |
| (mol/L) | acid (mol/L) | acid (mol/L) | kenaf) | (%) |
| 9.97 | 0 | 0 | 2.94 | 3 |
| 8.97 | 1.55 | 0 | 10.78 | 12 |
| 7.97 | 3.1 | 0 | 13.72 | 15 |
| 8.97 | 0 | 1.55 | 16.17 | 19 |
| 7.97 | 0 | 3.1 | 40.18 | 51 |

As shown in Table 1, when the hydrogen peroxide solution acted on the kenaf bast fiber, the peroxide group was able to be introduced in the kenaf bast fiber surface, and further the styrene was able to be graft-polymerized.

### Embodiment 2

A kenaf bast fiber washed with water was immersed in an orthoperiodic acid solution of 20 mmol/L for one hour at a temperature of 45° C., and thereby a surface of the fiber was oxidized. Subsequently, the kenaf bast fiber was placed in a polymerization tube, along with hydrogen peroxide solution having a predetermined concentration, and a methansulfonic acid or an acetic acid. The kenaf bast fiber was held therein for three hours at a temperature of 30° C. Thereby, a peroxide group was introduced in the fiber surface. An amount of the introduced peroxide group was then measured.

Meanwhile, the fiber in which the peroxide group was introduced in the surface was placed in a polymerization tube, along with a predetermined amount of styrene and the same mount of water. The styrene was then graft-polymerized on the fiber surface for 12 hours at a temperature of 60° C. in a nitrogen atmosphere. Thereafter, a soxhlet extraction was performed so as to remove impurities not grafted on the fiber surface. A graft rate was then obtained as follows: [(Post-graft weight−Pre-graft weight)/Pre-graft weight]×100%. The results are shown in Table 2 below.

TABLE 2

| | | | Peroxide | |
|---|---|---|---|---|
| Hydrogen | | | group amount | |
| peroxide | Methansulfonic | Acetic acid | (meq/100 g | Graft rate |
| (mol/L) | acid (mol/L) | (mol/L) | kenaf) | (%) |
| 9.97 | 0 | 0 | 10.91 | 61 |
| 8.97 | 1.55 | 0 | 29.40 | 208 |
| 7.97 | 3.1 | 0 | 25.97 | 182 |
| 8.97 | 0 | 1.73 | 30.87 | 210 |
| 7.97 | 0 | 3.46 | 27.93 | 196 |

As shown in Table 2, when hydrogen peroxide solution acted on the kenaf bast fiber after the treatment with the orthoperiodic acid, the peroxide group was able to be introduced in the kenaf bast fiber surface, and further the styrene was able to be graft-polymerized at a graft rate of 60% or greater.

### Embodiment 3

A kenaf bast fiber washed with water was placed between two electrodes provided in a bell-jar type plasma reactor. The reactor was deaerated to 5 Pa, and then oxygen was introduced so as to stabilize the inside pressure to 20 Pa. Subsequently, a predetermined voltage was supplied between the electrodes from an RF high-frequency power source (13.56 MHz) connected to one of the electrodes, and thus plasma was generated. The fiber placed between the electrodes was irradiated with plasma for a predetermined time, and thereby a peroxide group was introduced in the fiber surface. An amount of the introduced peroxide group was then measured.

Meanwhile, the fiber in which the peroxide group was introduced in the surface was placed in a polymerization tube, along with a predetermined amount of styrene and the same mount of water. The styrene was then graft-polymerized on the fiber surface for 12 hours at a temperature of 60° C. in a nitrogen atmosphere. Thereafter, a soxhlet extraction was performed so as to remove impurities not grafted on the fiber surface. A graft rate was then obtained as follows: [(Post-graft weight−Pre-graft weight)/Pre-graft weight]×100%. The results are shown in Table 3 below.

TABLE 3

| Irradiation | Plasma | Peroxide | Graft |
|---|---|---|---|
| time | power | group amount | rate |
| (minute) | (W) | (meq/100 g kenaf) | (%) |
| 5 | 10 | 1.49 | 2 |
| 15 | 10 | 4.95 | 5 |
| 5 | 50 | 2.48 | 3 |
| 12 | 50 | 5.94 | 7 |
| 15 | 50 | 6.93 | 8 |

As shown in Table 3, when plasma acted on the kenaf bast fiber, the peroxide group was able to be introduced in the fiber surface, and further the styrene was able to be graft-polymerized.

### Embodiment 4

The kenaf fiber obtained in Embodiment 2 and impact resistant PS were mixed, such that a kenaf fiber content was 40 weight %, the kenaf fiber having PS of 61 weight % of an original fiber weight bonded to the fiber. The mixture was kneaded, and thereby a kneaded material was obtained. Subsequently, the obtained kneaded material was filled in a vacuum hot press mold mounted with a spacer having a thickness of 1 mm. Then, the kneaded material was held and hot pressed under reduced pressure for eight minutes at a heating temperature of 200° C. and a pressure of 20 MPa, whereby a flat shaped composite material was obtained. Then, the obtained material was cut into a shape defined by JISK 7160 #4 using a dumbbell cutter.

### Comparative Example 1

Impact resistant PS was filled in a vacuum hot press mold mounted with a spacer having a thickness of 1 mm. Then, the material was held and hot pressed under reduced pressure for eight minutes at a heating temperature of 200° C. and a pressure of 20 MPa, whereby a flat shaped composite material was obtained. Then, the obtained material was cut into a shape defined by JISK 7160 #4 using a dumbbell cutter.

### Comparative Example 2

A kenaf bast fiber washed with water and impact resistant PS were mixed, such that a kenaf fiber content was 40 weight %. The mixture was kneaded, and thereby a kneaded material was obtained. Subsequently, the obtained kneaded material was filled in a vacuum hot press mold mounted with a spacer having a thickness of 1 mm. Then, the kneaded material was held and hot pressed under reduced pressure for eight minutes at a heating temperature of 200° C. and a pressure of 20 MPa, whereby a flat shaped composite material was obtained. Then, the obtained material was cut into a shape defined by JISK 7160 #4 using a dumbbell cutter.

### Comparative Evaluation 1

Tensile strength was measured for each of the materials obtained in Embodiment 4 and Comparative Examples 1 and 2. The results are shown in Table 4 below.

TABLE 4

| | | Comparative | Comparative |
|---|---|---|---|
| | Embodiment 4 | Example 1 | Example 2 |
| Tensile | 23.7 | 21.3 | 15.7 |
| strength | | | |
| (MPa) | | | |

As shown in Table 4, the composite material of Embodiment 4 demonstrated superior mechanical strength compared to the material of PS alone of Comparative Example 1. Further, the composite material demonstrated superior mechanical strength to conventional NFRP of Comparative Example 2. In addition, it was easy to form and process the composite material of Embodiment 4.

### Embodiment 5

PP polymerized powder having undergone swelling in cyclohexane at a temperature of 78° C. was used as a synthetic polymer; a methacryloxypropyltrimethoxysilane was used as a vinyl group-containing alkoxysilane monomer; and a xanthone was used as a radical generator. The PP and methacryloxypropyltrimethoxysilane were immersed in a solution in which xanthone was dissolved, and then irradiated with ultraviolet having a wavelength of 300 nm or greater while being stirred in a nitrogen atmosphere. Thereby, powder was obtained having PP graft-polymerized with methacryloxypropyltrimethoxysilane. Methanol was used as a solvent. The monomer had a concentration of 0.17 mol/L, and the radial generator had a concentration of 0.0014 mol/L. Light irradiation was performed using a 400 W high pressure mercury lamp at a solution temperature of 65° C. for a duration of four hours. A graft rate of the obtained powder was 9.3%.

Subsequently, a kenaf bast fiber washed with water was immersed for one hour in a solution having a temperature of 120° C. and then removed therefrom, the solution having PP graft-polymerized with an alkoxysilane group dissolved in xylene at a proportion of 12% of a weight of the kenaf fiber. The removed kenaf bast fiber was heat-dried at a temperature of 80° C. for 24 hours, and thereby a molecular chain of PP was chemically bonded to a surface of the kenaf bast fiber.

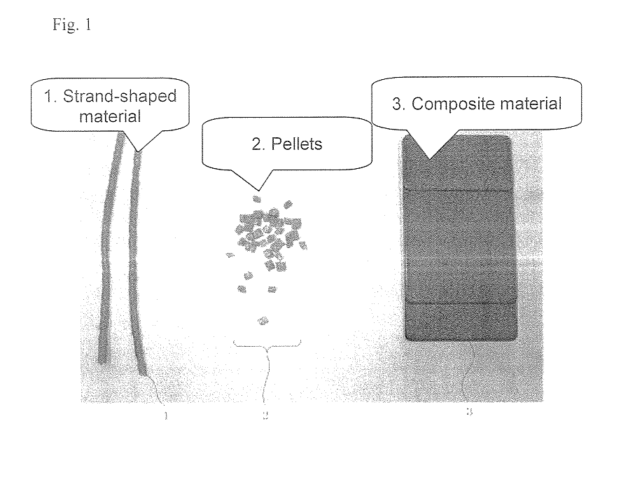

Thereafter, the chemically bonded kenaf bast fiber and the PP powder were mixed, such that a kenaf bast fiber content was 30 weight % or 50 weight %. The mixture was extrusion-molded at a temperature of 200° C. to 210° C. while being kneaded, and then formed into a strand shape as shown in FIG. 1. The material was cut into pellets. The pellets 2 were dried at a temperature of 80° C. for two hours, and then injection-molded at a molding temperature of 200° C. to 210° C. and a mold temperature of 80° C. Thereby, a flat-shaped test piece was obtained as a composite material 3. Thereafter, the material was cut into a shape defined by JISK 7160 #4 using a dumbbell cutter. FIG. 1 shows the strand-shaped material 1, the pellets 2, and the composite material 3.

### Comparative Example 3

PP powder was extrusion-molded at a temperature of 200° C. to 210° C., formed into a strand shape, and then cut into pellets. Then, the pellets were injection-molded at a molding temperature of 200° C. to 210° C. and a mold temperature of 80° C., and thereby a flat-shaped material was obtained. Thereafter, the material was cut into a shape defined by JISK 7160 #4 using a dumbbell cutter.

### Comparative Example 4

A kenaf bast fiber washed with water and PP powder were mixed, such that a kenaf bast fiber content was 30 weight % or 50 weight %. The mixture was extrusion-molded at a temperature of 200° C. to 210° C. while being kneaded, formed into a strand shape, and then cut into pellets. The pellets were dried at a temperature of 80° C. for two hours, and then injection-molded at a molding temperature of 200° C. to 210° C. and a mold temperature of 80° C. Thereby, a flat-shaped composite material was obtained. Thereafter, the material was cut into a shape defined by JISK 7160 #4 using a dumbbell cutter.

### Comparative Example 5

A glass fiber and PP powder were mixed, such that a glass fiber content was 20 weight %. The mixture was kneaded, and thus the kneaded material was obtained. The obtained kneaded material was extrusion-molded at a temperature of 200° C. to 210° C., formed into a strand shape, and then cut into pellets. The pellets were injection-molded at a molding temperature of 200° C. to 210° C. and a mold temperature of 80° C. Thereby, a flat-shaped composite material was obtained. Thereafter, the material was cut into a shape defined by JISK 7160 #4 using a dumbbell cutter.

### Comparative Evaluation 2

A fill amount, tensile strength, and elongation modulus were measured for each of the materials obtained in Embodiment 5 and Comparative Examples 3, 4, and 5. The results are shown in Table 5 below.

TABLE 5

| | | | Comparative | Comparative | | Comparative |
|---|---|---|---|---|---|---|
| Fill amount | Embodiment 5 | | Example 3 | Example 4 | | Example 5 |
| (weight %) | 30 | 50 | 0 | 30 | 50 | 20 |
| Tensile | 35.8 | 38.4 | 30.4 | 26.1 | 25.3 | 37.6 |
| strength | | | | | | |
| (MPa) | | | | | | |
| Elongation | 3.7 | 4.1 | 2.9 | 3.1 | 3.3 | 4.2 |
| modulus | | | | | | |
| (GPa) | | | | | | |

As shown in Table 5, the composite material of Embodiment 5 demonstrated superior mechanical strength compared to the material of PP alone of Comparative Example 3 or the composite material of untreated kenaf fiber and PP of Comparative Example 4. The composite material of Embodiment 5 exhibited mechanical strength even comparable to the composite material of glass fiber and PP of Comparative Example 5.

### Embodiment 6

A low-density PE film (thickness of 30 μm) was used as a synthetic polymer; a methacryloxypropyltrimethoxysilane was used as a vinyl group-containing alkoxysilane monomer; and a xanthone was used as a radical generator. The low-density PE film was first immersed for 10 seconds in an acetone solution in which xanthone and polyvinyl acetate were dissolved, and then removed therefrom. The low-density PE film was dried and provided as a xanthone-applied film. The xanthone-applied film was immersed in a methanol solution of methacryloxypropyltrimethoxysilane, and irradiated with ultraviolet having a wavelength of 300 nm or greater in a nitrogen atmosphere. Thereby, a film was obtained having low-density PE graft-polymerized with methacryloxypropyltrimethoxysilane. The monomer had a concentration of 0.14 mol/L, and the radial generator had a concentration of 0.3 weight %. Light irradiation was performed using a 400 W high pressure mercury lamp at a solution temperature of 60° C. for 100 minutes. A graft rate of the obtained film was 8%.

Subsequently, a kenaf bast fiber washed with water was immersed for one hour in a solution having a temperature of 80° C. and then removed therefrom, the solution having low-density PE graft-polymerized with an alkoxysilane group dissolved in a xylene at a proportion of 4% of a weight of the kenaf fiber. The removed kenaf bast fiber was heat-dried at a temperature of 80° C. for 24 hours, and thereby a molecular chain of low-density PE was chemically bonded to a surface of the kenaf bast fiber. When the chemically bonded kenaf bast fiber was immersed in water for 24 hours at a room temperature, a water absorption rate was measured 1.7%. The water absorption rate was extremely reduced compared to a water absorption rate of 4.0% measured when an untreated kenaf fiber was similarly immersed in water.

Thereafter, the chemically bonded kenaf bast fiber and straight-chain low-density PE pellets were mixed, such that a kenaf bast fiber content was 40 weight %. The mixture was filled in a vacuum hot press mold mounted with a spacer having a thickness of 1 mm. Then, the mixture was held and hot pressed under reduced pressure for two minutes at a heating temperature of 200° C. and a pressure of 15 MPa, whereby a flat shaped composite material was obtained. Then, the obtained material was cut into a shape defined by JISK 7160 #4 using a dumbbell cutter.

### Comparative Example 6

Straight-chain low-density PE pellets were filled in a vacuum hot press mold mounted with a spacer having a thickness of 1 mm. Then, the pellets were held and hot pressed under reduced pressure for two minutes at a heating temperature of 200° C. and a pressure of 15 MPa, whereby a flat shaped composite material was obtained. Then, the obtained material was cut into a shape defined by JISK 7160 #4 using a dumbbell cutter.

### Comparative Example 7

A kenaf bast fiber washed with water and straight-chain low-density PE pellets were mixed, such that a kenaf bast fiber content was 40 weight %. The mixture was filled in a vacuum hot press mold mounted with a spacer having a thickness of 1 mm. Then, the mixture was held and hot pressed under reduced pressure for two minutes at a heating temperature of 200° C. and a pressure of 15 MPa, whereby a flat shaped composite material was obtained. Then, the obtained material was cut into a shape defined by JISK 7160 #4 using a dumbbell cutter.

### Comparative Evaluation 3

Tensile strength and elongation modulus were measured for each of the materials obtained in Embodiment 6 and Comparative Examples 6 and 7. The results are shown in Table 6 below.

TABLE 6

| | | Comparative | Comparative |
|---|---|---|---|
| | Embodiment 6 | Example 6 | Example 7 |
| Tensile | 37.1 | 9.9 | 7.8 |
| strength | | | |
| (MPa) | | | |
| Elongation | 739 | 142 | 341 |
| modulus | | | |
| (MPa) | | | |

As shown in Table 6, the composite material of Embodiment 6 demonstrated superior mechanical strength compared to the material having straight-chain low-density PE alone of Comparative Example 7 and the composite material of untreated kenaf fiber and straight-chain low-density PE of Comparative Example 8.

### Embodiment 7

PS powder (grain size of 250 μm to 350 μm) was used as a synthetic polymer; a methacryloxypropyltrimethoxysilane was used as a vinyl group-containing alkoxysilane monomer; and a xanthone was used as a radical generator. The PS powder and methacryloxypropyltrimethoxysilane were immersed in a solution in which xanthone was dissolved, and then irradiated with ultraviolet having a wavelength of 300 nm or greater while being stirred in a nitrogen atmosphere. Thereby, powder was obtained having PS graft-polymerized with methacryloxypropyltrimethoxysilane. A solvent used contained methanol and toluene mixed at a ratio of 95:5. The monomer had a concentration of 0.35 mol/L, and the radial generator had a concentration of 0.00034 mol/L. Light irradiation was performed using a 400 W high pressure mercury lamp at a solution temperature of 65° C. for a duration of four hours. A graft rate of the obtained powder was 6.3%.

Subsequently, the PS graft-polymerized with the alkoxysilane group, a kenaf bast fiber washed with water, and impact resistant PS pellets were mixed, such that the weight of each material was 0.05:1:1. The mixture was extrusion-molded at a temperature of 180° C. to 200° C. while being kneaded, formed into a strand shape, and then cut into pellets. The pellets were dried at a temperature of 80° C. for two hours, and then filled in a vacuum hot press mold mounted with a spacer having a thickness of 1 mm. The pellets were held and hot pressed under reduced pressure for eight minutes at a heating temperature of 200° C. and a pressure of 20 MPa, whereby a flat shaped composite material was obtained.

### Comparative Example 8

Impact resistant PS pellets were filled in a vacuum hot press mold mounted with a spacer having a thickness of 1 mm. The pellets were held and hot pressed under reduced pressure for eight minutes at a heating temperature of 200° C. and a pressure of 20 MPa, whereby a flat shaped composite material was obtained.

### Comparative Example 9

A kenaf bast fiber washed with water and impact resistant PS pellets were mixed, such that the weight of each material was 1:1. The mixture was extrusion-molded at a temperature of 180° C. to 200° C. while being kneaded, formed into a strand shape, and then cut into pellets. Thereafter, the pellets were dried at a temperature of 80° C. for two hours, and then filled in a vacuum hot press mold mounted with a spacer having a thickness of 1 mm. The pellets were held and hot pressed under reduced pressure for eight minutes at a heating temperature of 200° C. and a pressure of 20 MPa, whereby a flat shaped composite material was obtained.

### Comparative Evaluation 4

Tensile strength was measured for each of the materials obtained in Embodiment 7 and Comparative Examples 8 and 9. The results are shown in Table 7 below.

TABLE 7

| | | Comparative | Comparative |
|---|---|---|---|
| | Embodiment 7 | Example 8 | Example 9 |
| Tensile | 36.0 | 33.7 | 22.3 |
| strength | | | |
| (MPa) | | | |

As shown in Table 7, the composite material of Embodiment 7 demonstrated superior mechanical strength compared to the material having impact resistant PS alone of Comparative Example 8 and the composite material of an untreated kenaf fiber and impact resistant PS of Comparative Example 9.

In the production method of the composite material composed of the natural vegetable fiber and the synthetic polymer according to the present invention, the composite material of natural fiber reinforced plastic can be obtained which is lightweight, mechanically strong, and excellent in formability and water resistance. Further, the composite material features no generation of residue that burdens the environment when being burned.

1. (canceled)

2. A production method of a composite material composed of a natural vegetable fiber and a synthetic polymer, the production method comprising:
chemically bonding a molecular chain of a polystyrene, which is the synthetic polymer, to a surface of the natural vegetable fiber by treating the natural vegetable fiber with hydrogen peroxide solution, and thus introducing a peroxide group in the fiber surface; and then by contacting a styrene, which is a vinyl monomer, to the fiber in which the peroxide group is introduced in the surface, and thus graft-polymerizing the polystyrene on the fiber surface using the peroxide group as a polymerization initiator;
kneading the fiber to which the molecular chain of the polystyrene is chemically bonded, and a synthetic polymer of a type one of identical to and different from the synthetic polymer used in the chemical bonding; and
forming the obtained kneaded material into a predetermined shape.

3. A production method of a composite material composed of a natural vegetable fiber and a synthetic polymer, the production method comprising:
chemically bonding a molecular chain of a polystyrene, which is the synthetic polymer, to a surface of the natural vegetable fiber by irradiating the natural vegetable fiber with plasma, and thus introducing a peroxide group in the fiber surface; and then by contacting a styrene, which is a vinyl monomers to the fiber in which the peroxide group is introduced in the surface, and thus graft-polymerizing the polystyrene on the fiber surface using the peroxide group as a polymerization initiator;
kneading the fiber to which the molecular chain of the polystyrene is chemically bonded, and a synthetic polymer of a type one of identical to and different from the synthetic polymer used in the chemical bonding; and
forming the obtained kneaded material into a predetermined shape.

4. A production method of a composite material composed of a natural vegetable fiber and a synthetic polymer, the production method comprising:
causing a radial generator to act on the synthetic polymer having one of a polypropylene, a polyethylene, and a polystyrene, in the presence of a methacryloxypropyltrimethoxysilane, which is a vinyl group-containing alkoxysilane monomer, and thus graft-polymerizing the alkoxysilane monomer on the synthetic polymer; and
chemically bonding a molecular chain of the synthetic polymer to a surface of the natural vegetable fiber by dehydrating and condensing an alkoxysilane group and a hydroxyl group, the alkoxysilane group being graft-polymerized on the synthetic polymer, the hydroxyl group being present in the surface of the natural vegetable fiber;
kneading the chemically bonded fiber and a synthetic polymer of a type one of identical to and different from the synthetic polymer used in the chemical bonding; and
forming the obtained kneaded material into a predetermined shape.

5. The production method according to claim 2, wherein the natural vegetable fiber is a kenaf fiber, the monomer is a styrene, and the synthetic polymer is a polystyrene.

6. The production method according to claim 4, wherein the natural vegetable fiber is a kenaf fiber, the monomer is a methacryloxypropyltrimethoxysilane, and the synthetic polymer is a polypropylene.

7. The production method according to claim 4, wherein the natural vegetable fiber is a kenaf fiber, the monomer is a methacryloxypropyltrimethoxysilane, and the synthetic polymer is a polyethylene.

8. The production method according to claim 4, wherein the natural vegetable fiber is a kenaf fiber, the monomer is a methacryloxypropyltrimethoxysilane, and the synthetic polymer is a polystyrene.

9. A composite material composed of a natural vegetable fiber and a synthetic polymer, the composite material being produced in the method according to claim 2.

10. The production method according to claim 3, wherein the natural vegetable fiber is a kenaf fiber, the monomer is a styrene, and the synthetic polymer is a polystyrene.

11. A composite material composed of a natural vegetable fiber and a synthetic polymer, the composite material being produced in the method according to claim 10.

12. A composite material composed of a natural vegetable fiber and a synthetic polymer, the composite material being produced in the method according to claim 3.

13. A composite material composed of a natural vegetable fiber and a synthetic polymer, the composite material being produced in the method according to claim 4.

14. A composite material composed of a natural vegetable fiber and a synthetic polymer, the composite material being produced in the method according to claim 5.

15. A composite material composed of a natural vegetable fiber and a synthetic polymer, the composite material being produced in the method according to claim 6.

16. A composite material composed of a natural vegetable fiber and a synthetic polymer, the composite material being produced in the method according to claim 7.

17. A composite material composed of a natural vegetable fiber and a synthetic polymer, the composite material being produced in the method according to claim 8.
